(19) United States
(12) Patent Application Publication
(10) Pub. No.: US 2011/0113041 A1
(43) Pub. Date: May 12, 2011

(54) System and method for content identification and customization based on weighted recommendation scores

(76) Inventors: Louis Hawthorne, Mill Valley, CA (US); d'Armond Lee Speers, Thornton, CO (US)

(21) Appl. No.: 12/916,762

(22) Filed: Nov. 1, 2010

Related U.S. Application Data
(63) Continuation-in-part of application No. 12/253,893, filed on Oct. 17, 2008.

(51) Int. Cl. G06F 17/30

(52) U.S. Cl. 707/749; 707/E17.108

(57) ABSTRACT

A new approach is proposed that contemplates systems and methods to present a script of content (also known as a user experience) comprising one or more content items to a user online, wherein such content is not only relevant to addressing a problem raised by the user, but is also customized and tailored to the specific needs and preferences of the user based on the user's profile. Here, the content generated and presented to the user can be predicted, identified, and selected by taking into account similarities between the user and users or experts in a community who share the same interest as the user as well as feedback on relevant content by the users in the community. With such an approach, a user can efficiently and accurately find what he/she is looking for and have a unique experience that distinguishes it from the experiences by any other person in the general public.

### RELATED APPLICATIONS

This application is a continuation-in-part of U.S. patent application Ser. No. 12/253,893, filed Oct. 17, 2008, and entitled “A system and method for content customization based on user profile,” by Hawthorne et al., and is hereby incorporated herein by reference.

### BACKGROUND

With the growing volume of content available over the Internet, people are increasingly seeking answers to their questions or problems online. Due to the overwhelming amount of information that is available online, however, it is often difficult for a lay person to browse over the Web and find the content that actually addresses his/her problem. Even when the user is able to find the content that is relevant to address his/her problem, such content is most likely to be of “one size fits all” type that addresses concerns of the general public while it does not target the specific needs of the user as an individual. Although some online vendors do keep track of web surfing and/or purchasing history or tendency of a user online for the purpose of recommending services and products to the user based on such information, such online footprint of the user is only passively gathered or monitored, which often does not truly reflect the user's real intention or interest. For a non-limiting example, the fact that a person purchased certain goods as gifts for his/her friend(s) is not indicative of his/her own interest in such goods. Furthermore, the content that the user desires may be similar to content previously reviewed by him/her and/or other users or experts in a community who share the same interest as the user. Such user preferences have not been accounted for during content identification and selection.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support content customization based on user profile.

FIG. 2 illustrates an example of the various information that may be included in a user profile.

FIG. 3 depicts a flowchart of an example of a process to establish the user's profile.

FIG. 4 illustrates an example of various types of content items in a script of content and the potential elements in each of them.

FIG. 5 depicts a flowchart of an example of a process to perform content similarity and recommendation calculation at run-time.

FIG. 6 depicts a flowchart of an example of a process to perform content similarity calculation at index-time and recommendation calculation at run-time.

FIG. 7 depicts a flowchart of an example of a process to adjust recommendation scores for the user based upon an analysis of the user's prior feedback.

FIG. 8 depicts a flowchart of an example of a process to support content customization based on user profile.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to present a script of content (also known as a user experience, referred to hereinafter as “content”) comprising one or more content items to a user online, wherein such content is not only relevant to addressing a problem raised by the user, but is also customized and tailored to the specific needs and preferences of the user based on the user's profile. Here, the content generated and presented to the user can be predicted, identified, and selected by taking into account similarities between the user and users or experts in a community who share the same interest as the user as well as feedback on relevant content by the users in the community. With such an approach, a user can efficiently and accurately find what he/she is looking for and have a unique experience that distinguishes it from the experiences by any other person in the general public.

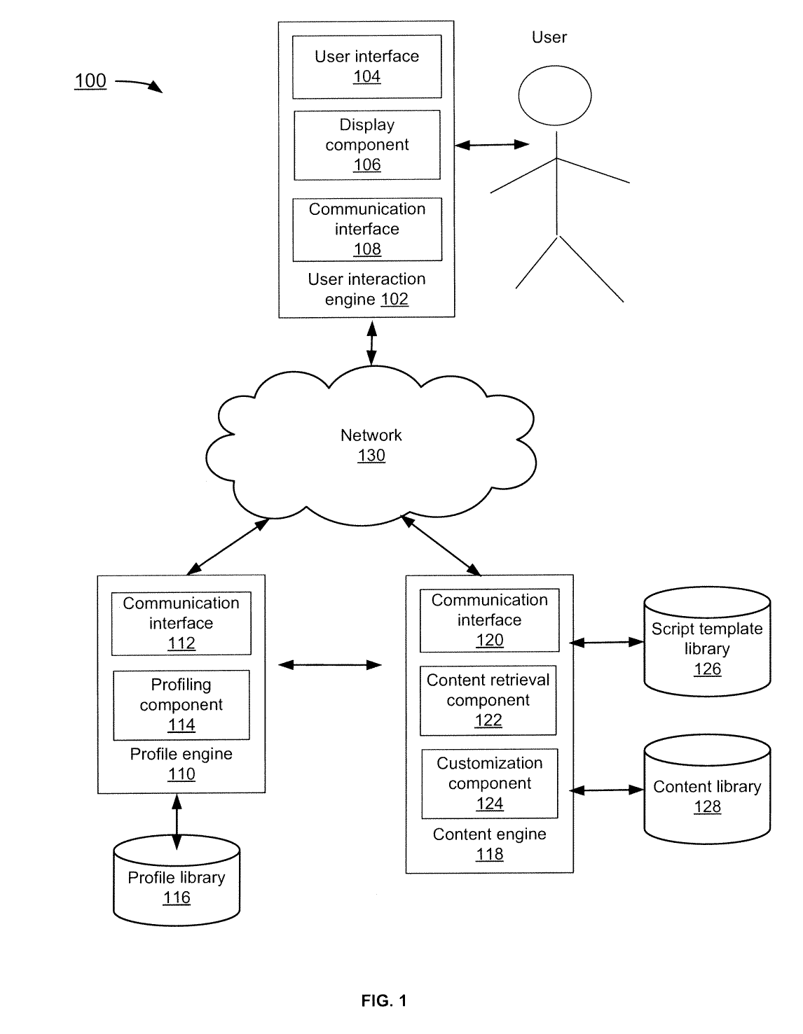

FIG. 1 depicts an example of a system diagram to support content customization based on user profile. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a user interaction engine 102, which includes at least a user interface 104, a display component 106, and a communication interface 108; a profile engine 110, which includes at least a communication interface 112 and a profiling component 114; a profile library (database) 116 coupled to the profile engine 110; a content engine 118, which includes at least a communication interface 120, a content retrieval component 122, and a customization component 124; a script template library (database) 126 and a content library (database) 128, both coupled to the content engine 118; and a network 130.

As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise.

In the example of FIG. 1, each of the engines and libraries can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, an iPod, a PDA, or a server machine. A storage device can be but is not limited to a hard disk drive, a flash memory drive, or any portable storage device. A communication device can be but is not limited to a mobile phone.

In the example of FIG. 1, the communication interface 108, 112, and 120 are software components that enables the user interaction engine 102, the profile engine 110, and the content engine 118 to communicate with each other following certain communication protocols, such as TCP/IP protocol. The communication protocols between two devices are well known to those of skill in the art.

In the example of FIG. 1, the network 130 enables the user interaction engine 102, the profile engine 110, and the content engine 118 to communicate and interact with each other. Here, the network 130 can be a communication network based on certain communication protocols, such as TCP/IP protocol. Such network can be but is not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, the user interaction engine 102 is configured to enable a user to submit a problem to which the user intends to seek help or counseling via the user interface 104 and to present to the user a script of a content relevant to addressing the problem submitted by the user via the display component 106. Here, the problem (or question, interest, issue, event, condition, or concern, hereinafter referred to a problem) of the user provides the context for the content that is to the presented to him/her. The problem can be related to one or more of personal, emotional, spiritual, relational, physical, practical, or any other need of the user. In some embodiments, the user interface 104 can be a Web-based browser, which allows the user to access the system 100 remotely via the network 130.

In some embodiments, the user interaction engine 102 presents a pre-determined list of problems that could possibly be raised by the user in the form of a list, such as a pull down menu, and the user may submit his/her problem by simply picking and choosing a problem in the menu. Such menu can be organized by various categories or topics in more than one level. By organizing and standardizing the potential problems from the user, the menu not only saves the user's time and effort in submitting the problems, but also makes it easier to identify relevant script templates and/or content items for the problem submitted.

In some embodiments, the user interaction engine 102 is configured to enable the user to provide feedback to the content presented to him/her via the user interface 104. Here, such feedback can be, for non-limiting examples, scores, ratings or ranking of the content, indication of preference as whether the user would like to see the same or similar content in the same category in the future, or any written comments or suggestions on the content that eventually drives the customization of the content. For non-limiting examples, a score/rating can be from 0-10 where 0 is worst and 10 is best, or 5 stars. There can also be a comment by a user can be that he/she does not want to see content item such as poetry.

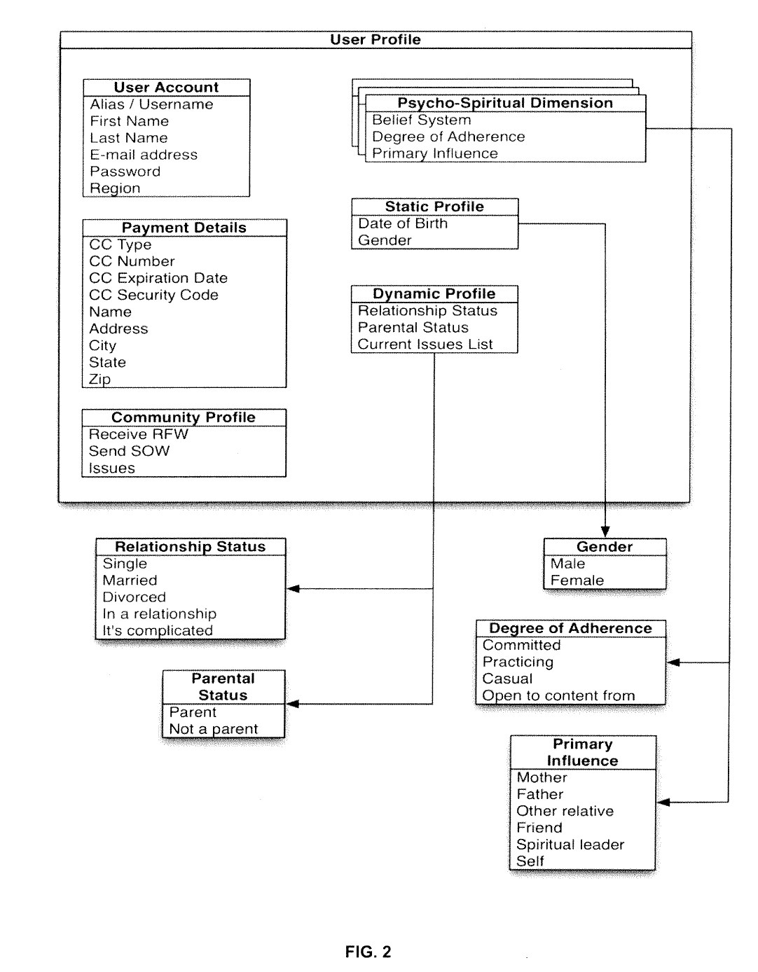

In the example of FIG. 1, the profile engine 110 manages a profile of the user maintained in the profile library 116 via the profiling component 114 for the purpose of generating and customizing the content to be presented to the user. The user profile may contain at least the following areas of user information:
Administrative information includes account information such as name, region, email address, and payment options of the user.
Static profile contains information of the user that does not change over time, such as the user's gender and date of birth to calculate his/her age and for potential astrological consideration.
Dynamic profile contains information of the user that may change over time, such as parental status, marital status, relationship status, as well as current interests, hobbies, habits, and concerns of the user.
Psycho-Spiritual Dimension describes the psychological, spiritual, and religious component of the user, such as the user's belief system (a religious, philosophical or intellectual tradition, e.g., Christian, Buddhist, Jewish, atheist, non-religious), degree of adherence (e.g., committed/devout, practicing, casual, no longer practicing, “openness” to alternatives) and influences (e.g., none, many, parents, mother, father, other relative, friend, spouse, spiritual leader/religious leader, sage, self).
Community Profile contains information defining how the user interacts with the online community of experts and professionals (e.g., which of the experts he/she likes or dislikes in the community and which problems to which the user is willing to receive request for wisdom (RFW) and to provide his/her own input on the matter).
   FIG. 2 illustrates an example of the various information that may be included in a user profile.

In some embodiments, the profile engine 110 initiates one or more questions to the user via the user interaction engine 102 for the purpose of soliciting and gathering at least part of the information listed above to establish the profile of the user. Here, such questions focus on the aspects of the user's life that are not available through other means. The questions initiated by the profile engine 110 may focus on the personal interests of the spiritual dimensions as well as dynamic and community profiles of the user. For a non-limiting example, the questions may focus on the user's personal interest, which may not be truly obtained by simply observing the user's purchasing habits.

In some embodiments, the profile engine updates the profile of the user via the profiling component 114 based on the prior history/record and dates of one or more of:
problems that have been raised by the user;
relevant content that has been presented to the user;
script templates that have been used to generate and present the content to the user;
feedback from the user to the content that has been presented to the user.

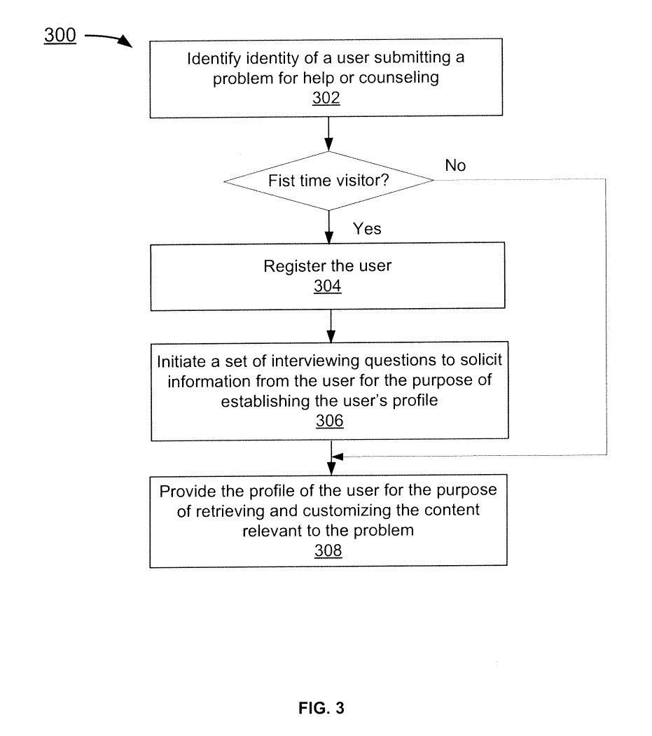

FIG. 3 depicts a flowchart of an example of a process to establish the user's profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 where identity of the user submitting a problem for help or counseling is identified. If the user is a first time visitor, the flowchart 300 continues to block 304 where the user is registered, and the flowchart 300 continues to block 306 where a set of interview questions are initiated to solicit information from the user for the purpose of establishing the user's profile. The flowchart 300 ends at block 308 where the profile of the user is provided to the content engine 118 for the purpose of retrieving and customizing the content relevant to the problem.

In the example of FIG. 1, the content engine 118 identifies and retrieves the content relevant to the problem submitted by the user via the content retrieval component 122 and customizes the content based on the profile of the user via customization component 124 in order to present to the user a unique experience. A script of content herein can include one or more content items, each of which can be individually identified, retrieved, composed, and presented by the content engine 118 to the user online as part of the user's multimedia experience (MME). Here, each content item can be, but is not limited to, a media type of a (displayed or spoken) text (for a non-limiting example, an article, a quote, a personal story, or a book passage), a (still or moving) image, a video clip, an audio clip (for a non-limiting example, a piece of music or sounds from nature), and other types of content items from which a user can learn information or be emotionally impacted. Here, each item of the content can either be provided by another party or created or uploaded by the user him/herself.

In some embodiments, each of a text, image, video, and audio item can include one or more elements of: title, author (name, unknown, or anonymous), body (the actual item), source, type, and location. For a non-limiting example, a text item can include a source element of one of literary, personal experience, psychology, self help, and religious, and a type element of one of essay, passage, personal story, poem, quote, sermon, speech, and summary. For another non-limiting example, a video an audio, and an image item can all include a location element that points to the location (e.g., file path or URL) or access method of the video, audio, or image item. In addition, an audio item may also include elements on album, genre, or track number of the audio item as well as its audio type (music or spoken word).

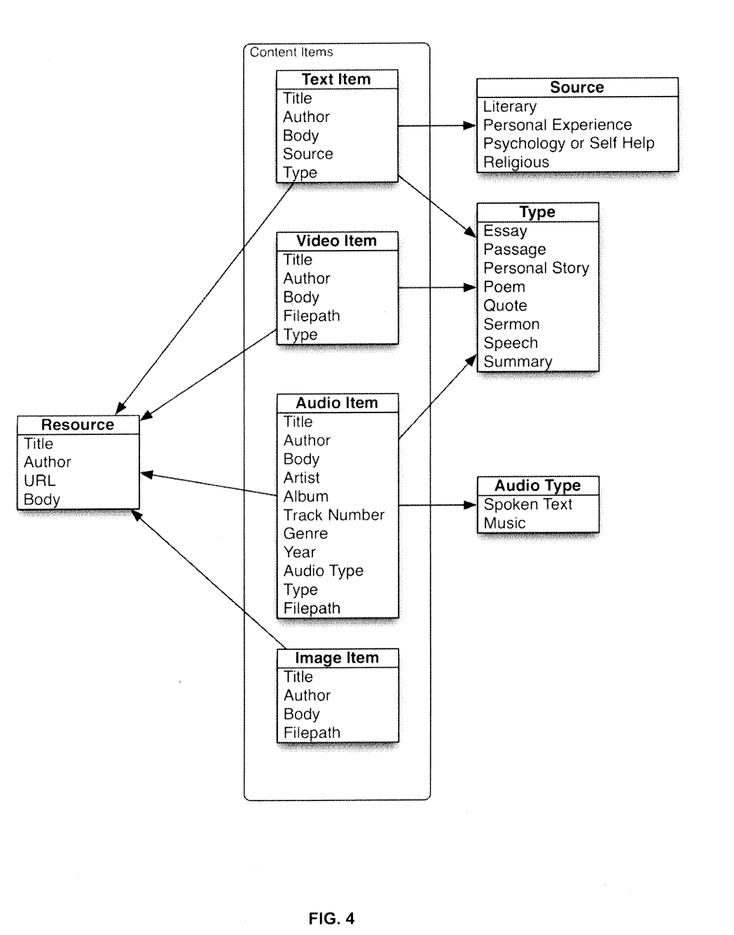

In some embodiments, the content engine 118 can associate each of a text, image, video, and audio item that is purchasable with a link to a resource of the item where such content item can be purchased from an affiliated vendor of the item, such as Amazon Associates, iTunes, etc. The user interaction engine 102 can then present the link together with the corresponding item in the content to the user and enable the user to purchase a content item of his/her interest by clicking the link associated with the content item. FIG. 4 illustrates an example of various types of content items and the potential elements in each of them.

In the example of FIG. 1, the content retrieval component 122 of the content engine 118 adapts collaborative filtering techniques to identify and retrieve content items relevant to the problem submitted by the user from the content library 128. More specifically, the content retrieval component 122 uses feedback scores on content items from a community of users or experts to make predictions about the content items that the user may like. Based on each user's feedback on the content items, the content retrieval component 122 learns about each user's preferences based upon the individual feedbacks and such content preferences from the community influences the selection of content for the user.

In some embodiments, the content retrieval component 122 of the content engine 118 may adopt two alternative approaches for the collaborative selection of content: the first approach is a run-time similarity and recommendation approach; the second approach separates similarity and recommendation between index-time and runtime execution for scalability and performance as the number of users in the community and their ratings increases. Both approaches start with the “target” user, i.e., the user discussed hereinabove for which the content is selected and return recommended content for that specific user.

### 1. Run-Time Similarity and Recommendation

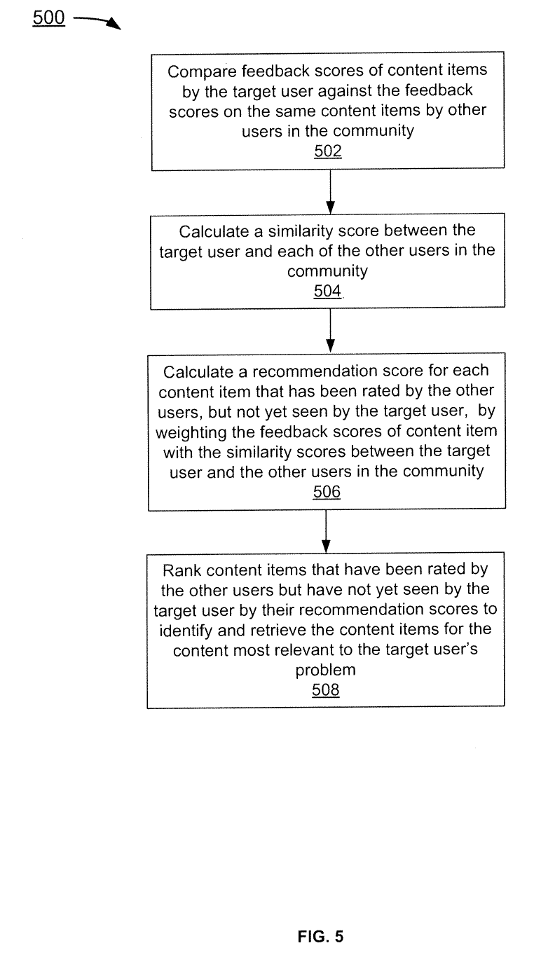

FIG. 5 depicts a flowchart of an example of a process to perform content similarity and recommendation calculation at run-time. In the example of FIG. 5, the flowchart 500 starts at block 502 where the content retrieval component 122 starts runtime similarity and recommendation by comparing the feedback scores of content items by the target user against the feedback scores on the same content items by other users in the community at run-time. The flowchart 500 continues to block 504 where a similarity score between the target user and each of the other users in the community is calculated. For a non-limiting example, this similarity score can be a Pearson correlation coefficient widely used for measuring of dependence and correlation between two quantities. The flowchart 500 continues to block 506 where a recommendation score for each of the content items that have been rated by the other users, but not yet seen by the target user, is calculated by weighting the feedback scores of the content item with similarity scores between the target user and the other users in the community. For a non-limiting example, if user A in the community with similarity score of 0.8 with the target user rates a content item with a feedback score of 5, while user B in the community with similarity score of 0.5 with the target user rates the same content item with a feedback score of 3, then the recommendation score of the content item for the target user is 5*0.8+3*0.5=5.5. The flowchart 500 ends at block 508 where the content retrieval component 122 ranks content items that have been rated by the other users but have not yet seen by the target user by their recommendation scores to identify and retrieve the content items for the content most relevant to the target user's problem. Since all the calculations are performed at run-time when the target user has submitted a problem and is requesting for content, this approach is preferable with a community of a small number of users and a small number of ratings on content items.

### 2. Index-Time Similarity and Run-Time Recommendation

Alternatively, the content retrieval component 122 starts similarity calculation at index-time by pushing as much of the calculation of similarities between the users to index-time as possible rather than run-time. Here, index-time calculations can be performed ahead of time, usually during periods of low server load, before the target user raises an issue/problem and requests content. When the user does submit a problem and request for content, the content retrieval component 122 can then perform more efficient calculation of recommendation score using the similarity scores that were pre-computed at index-time.

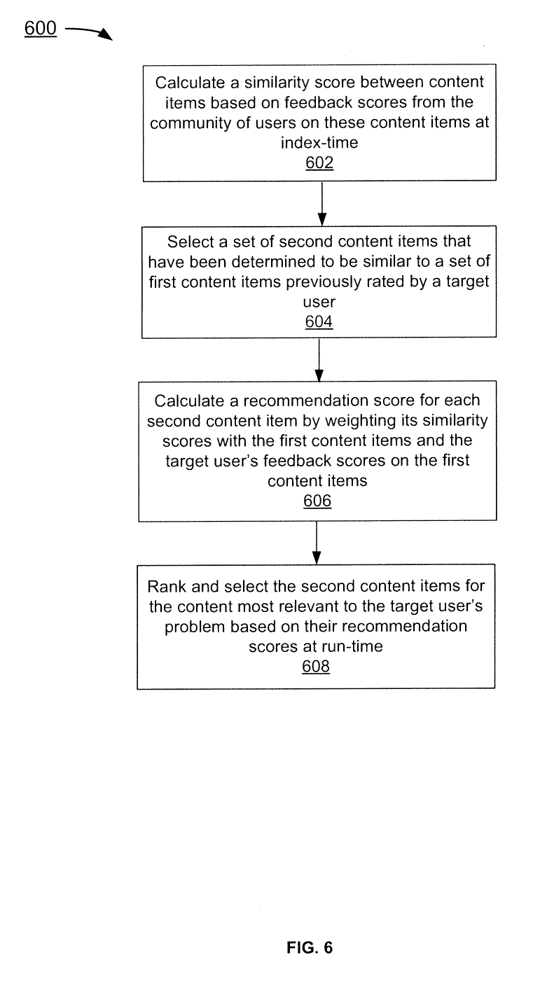

FIG. 6 depicts a flowchart of an example of a process to perform content similarity calculation at index-time and recommendation calculation at run-time. Unlike runtime similarity calculation, the flowchart 600 does not start index-time similarity calculation with the target user. Instead, the flowchart 600 starts at block 602 where a similarity score between each content item and each other content item in the content library 128 is calculated based on feedback scores from the community of users on these content items at index-time. These similarity scores are then stored for later use at run-time. When a target user requests for content at runtime, the flowchart 600 continues to block 604 where content items (second content items) that have been determined to be similar to content items (first content items) previously rated by the target user are selected. The flowchart 600 continues to block 606 where a recommendation score is calculated for each second content item by weighting and normalizing its similarity scores with the first content items and the target user's feedback scores on the first content items. For a non-limiting example, if the target user previously rated content item one A with a feedback score of 3, which has a similarity score of 0.5 with content item two, and content item one B with a feedback score of 6, which has a similarity score of 1 with content item two, the recommendation score for content item two would be 3*0.5+6*1=7.5. The flowchart 600 end at block 608 where second content items are ranked and selected for the content most relevant to the target user's problem based on their recommendation scores at run-time.

Note that both the runtime and index-time approaches discussed above effecting the recommendation scores derived from community scores depend upon some amount of scores for relevant content. In the event that there are not enough rated content items of a given type of content (also respecting other requirements such as filters and recurrence rules), the content retrieval component 122 falls back on a random selection of content without regard for feedback scores from users.

In both the run-time and index-time approaches discussed above, the content retrieval component 122 is able to make recommendations (predictions) for content items for the target user based upon comparisons to rating/feedback scores from the community of users. In some embodiments, the content retrieval component 122 further extends these approaches above to adjust recommendation scores calculated for the target user's content items based upon an analysis of the target user's prior feedback scores on content items independent of the collective feedback from the community of users. Such adjustment has the intended effect of reducing the dependency on large amounts of other users and their feedback scores as content retrieval component 122, is able to learn about the target user and adjust the selection of content items for that user based only upon that user's feedback scores.

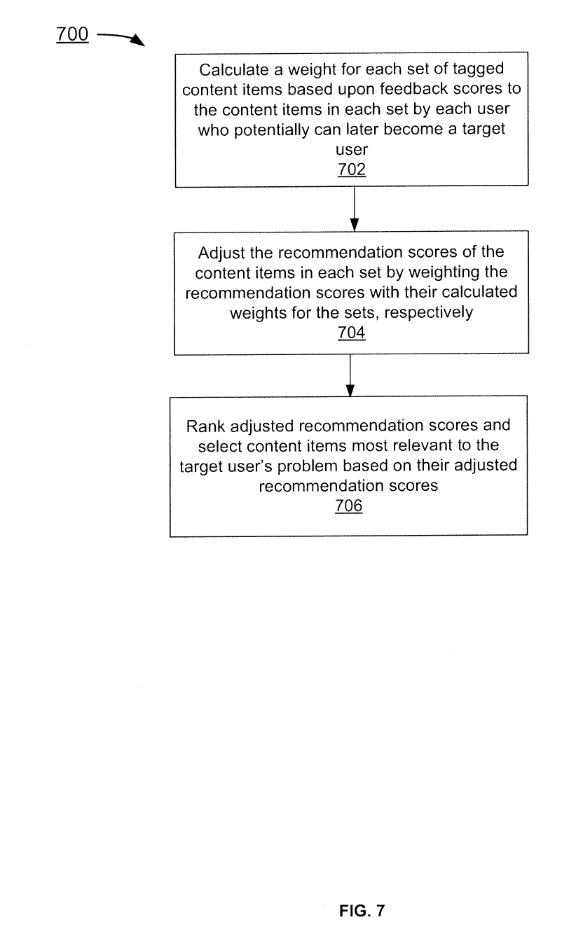

FIG. 7 depicts a flowchart of an example of a process to adjust recommendation scores for the target user based upon an analysis of the target user's prior feedback. In the example of FIG. 7, the content retrieval component 122 initially focuses the analysis of individual scores on content items (for which the recommendation scores have been calculated as described above) that belong to different sets tagged for, for non-limiting examples, a given tradition and a given sage. The flowchart 700 starts at block 702 where, for each user who potentially can become a target user later, a weight is calculated for each set of tagged content items based upon feedback scores to the content items in each set by the user. More specifically, for each user and each tradition, the content retrieval component 122 calculates a weight as the average feedback score for each content item in that tradition. Additionally, for each user and each sage, the content retrieval component 122 calculates a weight as the average feedback score for content related to that sage.

The flowchart 700 continues to block 704 where the recommendation scores of the content items in the tradition and sage sets are adjusted by weighting their recommendation scores with their calculated weights for the sets, respectively. Each recommended content item will have its recommendation score weighted by the tradition and sage weight related to that content item. For a non-limiting example, an average rating for a tradition or sage can be weighted according to the following scale:

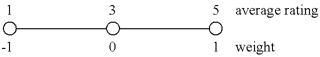

Here, an average rating of 3 will have a weight of 0, which will have no effect on the recommendation scores. An average rating of 1 (the lowest rating), however, will have a maximum negative weight of −1.0, which greatly reduces the impact of the recommendation score for the corresponding content item. An average rating of 5 (the highest score), on the other hand, will have a maximum positive weight of +1.0, which significantly increases impact of the recommendation score for the corresponding content item. If a content item is related to more than one tradition or sage, recommendation scores will be adjusted by the weights related to the average ratings of the multiple traditions and/or sages. The flowchart 700 ends at block 706 where the adjusted recommendation scores are ranked and content items most relevant to the target user's problem are selected based on their adjusted recommendation scores.

Note that since the recommendation score is itself computed from the ratings of other users in the community, the weighted recommendation approach described above is still dependent upon ratings by other users in the community. In order to allow the average rating scores to operate independently of community ratings in the event that there are not enough rated content items of a given type of content, the content retrieval component 122 may initially randomly select a content item in accordance with other requirements (such as t-filter and r-filter rules) and then adjust the likelihood of a content item being selected based upon the tradition and sage related to that item, utilizing the average feedback scores for that tradition and sage for the computation of the adjusted recommendation scores.

In some embodiments, the content retrieval component 122 may set the following limitations on content items (for a non-limiting example, text items) from one or more sets or categories, e.g., sages or traditions, which could dominate the result set for a target user to restrict their occurrence and thus reduce their dominance in any one of the categories:

a. Tradition Limit

In some embodiments, the content retrieval component 122 may restrict the number of content items that can be selected from any one tradition within a result set. The number of content items allowed from one tradition is dependent upon one or more of: (a) the number of traditions the target user is open to; (b) the number of content items in the set; and (c) a balancing factor. As the number of traditions the user is open to increases, the maximum number of content items allowed from any one tradition decreases as illustrated by the formula below:

$$t = \frac{n}{y - ( y - 1 ) \times ( 1 - bal \% )}$$

The content retrieval component 122 then restricts the maximum number of content items from any one tradition to t during the selection of content items. Here, y is the number of traditions the user is open to; n is the number of content items in a set; t is the maximum # of content items from one tradition, which can be rounded to the nearest integer; and bal % is the balancing factor that measures how evenly divided between traditions the user is open to the content items will be. If the balancing factor is 100%, the content items will be exactly evenly divided between traditions; If the balancing factor is 0%, the system will select content items without regard for the tradition they are from (possibly allowing content items from only one tradition).
b. Sage Limit

In some embodiments, the content retrieval component 122 may similarly restrict the number of content items that can be selected from any one sage. More specifically, each sage cannot be represented 1) more than one time in a sub-set; and 2) more than 2 times in a set. For a non-limiting example, content items have to be returned in three subsets (e.g., wave, pearl, dive) per result set.

In the example of FIG. 1, the content engine 118 may customize the content based on the user's profile including one or more of: the user's prior visits, his/her recent comments and ratings on content related to the same or relevant problems, and his/her response to requests for wisdom. For a non-limiting example, content items that did not appeal to the user in the past based on his/her feedback will likely be excluded. In some situations when the user is not sure what he/she is looking for, the user may simply choose “Get me through the day” from the problem list and the content engine 118 will automatically retrieve and present content to the user based on the user's profile. When the user is a first time visitor or his/her profile is otherwise thin, the content engine 118 may automatically identify and retrieve content items relevant to the problem.

In some embodiments, the content engine 118 may customize the content based on an “experience path” of the user. Here, the user experience path can be a psychological process (e.g., stages of grief: denial→anger→bargaining→depression→acceptance). The user experience path contains an ordered list of path nodes, each of which represents a stage in the psychological process. By associating the user experience path and path nodes with a content item, the content engine 118 can select appropriate content items for the user that are appropriate to his/her current stage in the psychological process.

In some embodiments, the content engine 118 may identify and retrieve the content in response to the problem raised by the user by identifying a script template for the problem submitted by the user and generating a script of the content by retrieving content items based on the script template. Here, a script template defines a sequence of media types with timing information for the corresponding content items to be composed as part of the multi-media content. For each type of content item in the content, the script template may specify whether the content item is repeatable or non-repeatable, how many times it should be repeated (if repeatable) as part of the script, or what the delay should be between repeats. For repeatable content Items, more recently viewed content Items should have a lower chance of selection that less recently viewed (or never viewed) content items.

In the example of FIG. 1, the profile library 116 embedded in a computer readable medium, which in operation, maintains a set of user profiles of the users. Once the content has been generated and presented to a user, the profile of the user stored in the profile library 116 can be updated to include the problem submitted by the user as well as the content presented to him/her as part of the user history. If the user optionally provides feedback on the content, the profile of the user can also be updated to include the user's feedback on the content.

In the example of FIG. 1, the script template library 126 maintains script templates corresponding to the pre-defined set of problems that are available to the user, while the content library 128 maintains content items as well as definitions, tags, and resources of the content relevant to the user-submitted problems. In some embodiments, the content engine 118 may automatically generate a script template for the problem by periodically data mining the relevant content items in the content library 128. More specifically, the content engine 118 may first browse through and identify content item's categories in the content library 128 that are most relevant to the problem submitted. The content engine 118 then determines the most effective way to present such relevant content items based on, for non-limiting examples, the nature of the content items (e.g., displayable or audible), and the feedback received from users as how they would prefer the content items to be presented to them to best address the problem. The content engine 118 then generates the script template for the problem and saves the template in the script library 126.

In the example of FIG. 1, the content library 128 covers both the definition of content items and how the content tags are applied. It may serve as a media “book shelf” that includes a collection of content items relevant and customized based on each user's profile, experiences, and preferences. The content engine 118 may retrieve content items either from the content library 128 or, in case the content items relevant are not available there, identify the content items over the Web and save them in the content library 128 so that these content items will be readily available for future use.

In some embodiments, the content items in content library 128 can be tagged and organized appropriately to enable the content engine 118 to access and browse the content library 128. Here, the content engine 118 may browse the content items by problems, types of content items, dates collected, and by certain categories such as belief systems to build the content based on the user's profile and/or understanding of the items' “connections” with the problem submitted by the user. For a non-limiting example, a sample music clip might be selected to be included in the content because it was encoded for a user with an issue of sadness.

In some embodiments, the content engine 118 may allow the user to add self-created content items (such as his/her personal stories, self-composed or edited images, audios, or video clips) into the content library 128 and make them available either for his/her own use only or more widely available to other users who may share the same problem with the user.

In some embodiments, the content engine 118 may occasionally include one or more content items in the customized content for the purpose of gathering feedback from the user. Here, the content items can be randomly selected by the content engine 118 from categories in the content library 128 that are relevant to the problem submitted by the user. Such content items may be newly generated and/or included in the content library 128 and have not been provided to users on a large scale. It is thus important to gather feedback on such content items from a group of users in order to evaluate via feedback such content.

In some embodiments, each content item in content library 128 can be associated with multiple tags for the purpose of easy identification, retrieval, and customization by the content engine 118 based on the user's profile. For a non-limiting example, a content item can be tagged as generic (default value assigned) or humorous (which should be used only when humor is appropriate). For another non-limiting example, a pair of (belief system, degree of adherence range) can be used to tag a content item as either appropriate for all Christians (Christian, 0-10) or only for devout Christians (Christian, 8-10). Thus, the content engine 118 will only retrieve a content item for the user where the tag of the content item matches the user's profile.

In some embodiments, the content engine 118 incorporates wisdom from a community of users and experts into the customized content. Here, the wisdom can simply be content items such as expert opinions and advice that have been supplied in response to a request for wisdom (RFW) issued by the user. The content items are treated just like any other content items once they are reviewed and rated/commented by the user.

While the system 100 depicted in FIG. 1 is in operation, the user interaction engine 102 enables the user to login and submit a problem of his/her concern via the user interface 104. The user interaction engine 102 communicates the identity of the user together with the problem raised by the user to the content engine 118 and/or the profile engine 110. If the user is visiting for the first time, the profile engine 110 may interview the user with a set of questions in order to establish a profile of the user that accurately reflects the user's interests or concerns. Upon receiving the problem and the identity of the user, the content engine 118 obtains the profile of the user from the profile library 116 and the script template of the problem from the script template library 126, respectively. The content engine 118 then identifies and retrieves content items based on similarities between the user and users or experts in a community who share the same interest as the user as well as feedback on relevant content by the users in the community. Once the content is generated, the user interaction engine 102 presents it to the user via the display component 106 and enables the user to rate or provide feedback to the content presented. The profile engine 110 may then update the user's profile with the history of the problems raised by the user, the content items presented to the user, and the feedback and ratings from the user of the content.

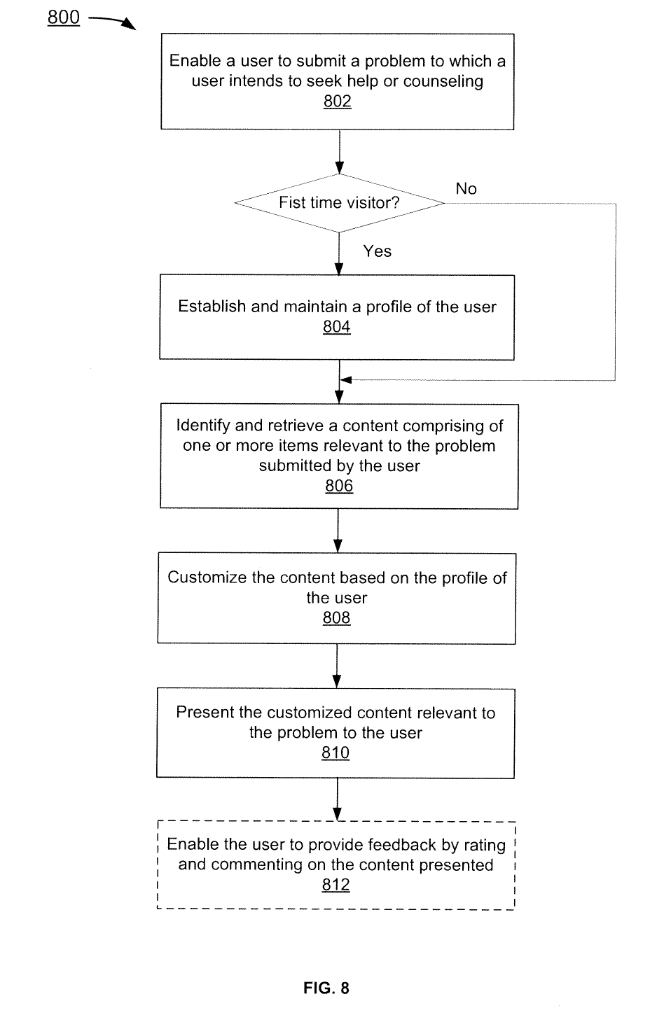

FIG. 8 depicts a flowchart of an example of a process to support content customization based on user profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 8, the flowchart 800 starts at block 802 where a user is enabled to submit a problem to which the user intends to seek help or counseling. The problem submission process can be done via a user interface and be standardized via a list of pre-defined problems organized by topics and categories.

In the example of FIG. 8, the flowchart 800 continues block 804 where a profile of the user is established and maintained if the user is visiting for the first time or the user's current profile is otherwise thin. At least a portion of the profile can be established by initiating interview questions to the user targeted at soliciting information on his/her personal interests and/or concerns. In addition, the profile of the user can be continuously updated with the problems raised by the user and the scripts of content presented to him/her.

In the example of FIG. 8, the flowchart 800 continues block 806 where a content comprising one or more content items that is relevant to the problem submitted by the user is identified and retrieved. Here, the content can be predicted, identified and retrieved by taking into account similarities between the user and users or experts in a community who share the same interest as the user as well as feedback on relevant content by the users in the community.

In the example of FIG. 8, the flowchart 800 continues block 808 where the retrieved content is customized based on the profile of the user. Such customization reflects the user's preference as to what kind of content items he/she would like to be included in the content, as well as how each of the items in the content is preferred to be presented to him/her.

In the example of FIG. 8, the flowchart 800 ends at block 810 where the customized content relevant to the problem is presented to the user. Optionally, the user may also be presented with links to resources from which items in the presented content can be purchased. The presented content items may also be saved for future reference.

In the example of FIG. 8, the flowchart 800 may optionally continue to block 812 where the user is enabled to provide feedback by rating and commenting on the content presented. Such feedback will then be used to update the profile of the user in order to make future content customization more accurate.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a user interaction engine, which in operation,
enables a user to submit a problem to which the user intends to seek help or counseling;
presents to the user a content relevant to addressing the problem submitted by the user;
a content engine, which in operation, identifies and retrieves the content relevant to the problem submitted by the user based on similarity between the user and a community of users or experts as well as feedback on the content from the community of users.

2. The system of claim 1, wherein:
the user interaction engine is configured to enable the user to provide feedback to the content presented.

3. The system of claim 1, wherein:
the problem submitted by the user relates to one or more of: personal, emotional, psychological, spiritual, relational, physical, practical, or any other needs of the user.

4. The system of claim 1, wherein:
the content includes one or more items, wherein each of the one or more items is a text, an image, an audio, or a video item.

5. The system of claim 4, wherein:
the content engine at run-time
compares feedback to the content items by the user against the feedback to the same content items by other users in a community; and
calculates a similarity score between the user and each of the other users in the community.

6. The system of claim 5, wherein:
the content engine at run-time further
calculates a recommendation score for each content item that has been rated by the other users but not yet seen by the user by weighting the feedback scores of the content item with the similarity scores between the target user and the other users in the community; and
ranks the content items by their recommendation scores to identify and retrieve the content items for the content most relevant to the target user's problem.

7. The system of claim 5, wherein:
the content engine calculates the similarly scores at index-time instead of run-time before the user submits the problem to seek help or counseling.

8. The system of claim 7, wherein:
the content engine at index-time
calculates a similarity score between the content items based on feedback scores from the community of users on these content items; and
selects a set of second content items that have been determined to be similar to a set of first content items previously rated by the user.

9. The system of claim 8, wherein:
the content engine at run-time
calculates a recommendation score for each second content item by weighting its similarity scores with the first content items and the user's feedback scores on the first content items; and
ranks and selects the second content items for the content most relevant to the target user's problem based on their recommendation scores.

10. The system of claim 1, wherein:
the content engine identifies and retrieves the content relevant to the problem submitted by the user without regard for feedback from the users.

11. The system of claim 4, wherein:
the content engine adjusts recommendation scores calculated for the user's content items based upon an analysis of the user's prior feedback on the content items independent of the collective feedback from a community of users.

12. The system of claim 11, wherein:
the content engine further
calculates a weight for each set of tagged content items based upon feedback scores to the content items in each set by the user;
adjusts the recommendation scores of the content items in each set by weighting the recommendation scores with their calculated weights for the sets, respectively;
ranks the adjusted recommendation scores and select content items most relevant to the user's problem based on their adjusted recommendation scores.

13. The system of claim 4, wherein:
the content engine sets limitations on content items from one or more categories which could dominate the content for the user to reduce their dominance in any one of the categories.

14. The system of claim 13, wherein:
the content engine restricts the number of content items that can be selected from any one category.

15. The system of claim 1, wherein:
the content engine customizes the content based on a profile of the user.

16. A computer-implemented method, comprising:
enabling a user to submit a problem to which the user intends to seek help or counseling;
identifying and retrieving a content including one or more content items relevant to the problem submitted by the user based on similarity between the user and a community of users or experts as well as feedback on the content from the community of users;
presenting the retrieved content relevant to the problem to the user.

17. The method of claim 16, further comprising:
enabling the user to provide feedback to the content presented.

18. The method of claim 16, further comprising:
comparing the feedback to the content items by the user against feedback to the same content items by other users in a community; and
calculating a similarity score between the user and each of the other users in the community at run-time.

19. The method of claim 18, further comprising:
calculating a recommendation score for each content item that has been rated by the other users but not yet seen by the user by weighting the feedback scores of the content item with the similarity scores between the target user and the other users in the community; and
ranking the content items by their recommendation scores to identify and retrieve the content items for the content most relevant to the target user's problem at run-time.

20. The method of claim 18, further comprising:
calculating the similarly scores at index-time instead of run-time before the user submits the problem to seek help or counseling.

21. The method of claim 20, further comprising:
calculating a similarity score between the content items based on feedback scores from the community of users on these content items; and
selecting a set of second content items that have been determined to be similar to a set of first content items previously rated by the user at index-time.

22. The method of claim 21, further comprising:
calculating a recommendation score for each second content item by weighting its similarity scores with the first content items and the user's feedback scores on the first content items; and
ranking and selecting the second content items for the content most relevant to the user's problem based on their recommendation scores.

23. The method of claim 16, further comprising:
identifying and retrieving the content relevant to the problem submitted by the user without regard for feedback from the users.

24. The method of claim 16, further comprising:
adjusting recommendation scores calculated for the user's content items based upon an analysis of the user's prior feedback on the content items independent of the collective feedback from a community of users.

25. The method of claim 24, further comprising:
calculating a weight for each set of tagged content items based upon feedback scores to the content items in each set by the user;
adjusting the recommendation scores of the content items in each set by weighting the recommendation scores with their calculated weights for the sets, respectively;
ranking the adjusted recommendation scores and select content items most relevant to the user's problem based on their adjusted recommendation scores.

26. The method of claim 16, further comprising:
setting limitations on content items from one or more categories which could dominate the content for the user to reduce their dominance in any one of the categories.

27. The method of claim 26, further comprising:
restricting the number of content items that can be selected from any one category.

28. The method of claim 16, further comprising:
customizing the content based on a profile of the user.

29. A machine readable medium having software instructions stored thereon that when executed cause a system to:
enable a user to submit a problem to which the user intends to seek help or counseling;
identify and retrieve a content including one or more content items relevant to the problem submitted by the user based on similarity between the user and a community of users or experts as well as feedback on the content from the community of users;
present the retrieved content relevant to the problem to the user.
